(19) United States
(12) Patent Application Publication
(10) Pub. No.: US 2026/0064420 A1
(43) Pub. Date: Mar. 5, 2026

(54) PROVIDING BYTECODE-LEVEL PARALLELISM IN A PROCESSOR USING CONCURRENT INTERVAL EXECUTION

(71) Applicant: Intel Corporation, Santa Clara, CA (US)

(72) Inventors: Yuan CHEN, Shanghai (CN); David B. SHEFFIELD, Portland, OR (US); Qi ZHANG, Shanghai (CN); Michael W Chynoweth, Placitas, NM (US)

(21) Appl. No.: 19/106,190

(22) PCT Filed: Sep. 30, 2022
(86) PCT No.: PCT/CN2022/123654

§ 371 Date: Feb. 24, 2025

(51) Int. Cl. G06F 9/38; G06F 9/30

(52) U.S. Cl. CPC G06F 9/3804; G06F 9/30058; G06F 9/3856

(57) ABSTRACT

In one embodiment, an apparatus comprises: a first plurality of registers to store information of at least a main sequence; a second plurality of registers to store information of at least one concurrent interval, the at least one concurrent interval independent of the main sequence, where the second plurality of registers are accessible only by instructions of the at least one concurrent interval and the first plurality of registers are accessible by instructions of the main sequence and the at least one concurrent interval; and an execution circuit coupled to the first register file and the second register file, the execution circuit to execute the instructions of the main sequence and the at least one concurrent interval. Other embodiments are described and claimed.

### BACKGROUND

Dynamically typed languages such as Javascript and Python use an interpreter to execute bytecodes at runtime. Each bytecode usually takes a unitary action via a handler and the instructions inside the handler are often highly dependent. On the other hand, some consecutive bytecodes may be independent and can execute in parallel.

Even when a processor supports out-of-order (OOO) execution for instruction level parallelism (ILP), the handlers are fetched in sequence, which prevents full utilization of out-of-order execution resources of the processor.

### BRIEF DESCRIPTION OF THE DRAWINGS

FIG. 1 is a block diagram of a processor core in accordance with an embodiment.

FIG. 2 is a flow diagram of a method in accordance with an embodiment.

FIG. 3 illustrates examples of computing hardware to process one or more cointerval instructions.

FIG. 4 illustrates an example method performed by a processor to process a cointerval instruction.

FIG. 5 illustrates an example method to process a cointerval instruction using emulation or binary translation.

FIG. 6 illustrates an example computing system.

FIG. 7 illustrates a block diagram of an example processor and/or System on a Chip (SoC) that may have one or more cores and an integrated memory controller.

FIG. 8(A) is a block diagram illustrating both an example in-order pipeline and an example register renaming, out-of-order issue/execution pipeline according to examples.

FIG. 8(B) is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

FIG. 11 is a block diagram illustrating the use of a software instruction converter to convert binary instructions in a source instruction set architecture to binary instructions in a target instruction set architecture according to examples.

### DETAILED DESCRIPTION

In various embodiments, a processor is configured with hardware structures to enable execution of concurrent intervals that the processor can fetch instructions and execute simultaneously with a main code sequence. These concurrent intervals are part of a single thread that also includes the main code sequence, and thus do not implicate multi-threaded control, e.g., by an operating system. That is, a main code sequence and one or more concurrent intervals form a single thread, in contrast to a multi-threaded application, which includes separate software threads that are independently fetched, decoded and executed. As a result, in one or more embodiments this concurrent interval arrangement is provided in a manner transparent to an operating system.

As will be discussed herein, the hardware that enables concurrent interval execution includes additional next instruction pointer storage, additional queue structures, and an additional register file (termed a “cointerval” register file or “coreg,” where the term “cointerval” is shorthand for “concurrent interval”). In one or more embodiments, these additional structures may be used to support the fetch, decode and execution of multiple intervals concurrently in the same thread as the main execution sequence.

As used herein, the term “concurrent interval” refers to a subset of instructions of a given thread that may be executed independently from other instructions (e.g., of a main instruction sequence and/or one or more subsets of instructions of the thread), rather than a duration of time. As used herein, the terms “concurrent interval,” “sub-thread,” and “concurrent flow” may be used interchangeably.

Embodiments may improve instruction level parallelism at a larger scope across bytecode handlers or subroutines or range of intervals. Fine-grained parallelism may be realized at the bytecode/block level to enhance processor capabilities without the cost of multi-core or multi-threading operation. It can be extensible to broader areas like coroutines in asynchronous programming. In contrast to conventional thread-level parallelism and speculation, the techniques described herein are more lightweight by reducing interaction with threading through an operating system, with most resources sharing architecture state, stack frame, even common registers.

A concurrent interval (cointerval) is a range of an instruction sequence that is part of a thread (where this range is normally highly dependent within the range, but independent of other instructions of the thread). Thus the concurrent interval can run independently to other intervals or code sequences. The concurrent interval uses two sets of architectural registers: common and cointerval registers. Common registers are shared across the main sequence and all cointervals. They are used to store global data that are accessible both inside and outside the concurrent intervals, such as environment flags representing architecture states, frame registers and all general registers. Common registers are allocated as inputs or outputs of the concurrent intervals for data transmission that will share architecture states, frame registers, etc.

In one or more embodiments, cointerval registers (coreg's) can only be read and written within the interval as temporary data. Note that all stack frames can be pre-allocated in the synchronized main sequence outside cointervals to avoid converged access to stack pointers.

Referring now to Table 1, shown is an example code sequence including cointervals. More specifically, blocks 11 and 12 are concurrent intervals that can execute concurrently with the main sequence (which begins as the instruction “mov r1<-src1”).

TABLE 1

| . . . | |
|---|---|
| IP: | mov r1 <- src1 |
| | cointerval I1 |
| | mov r2 <- src2 |
| | cointerval I2 |
| | cowait |
| | add r5 <- r3, r4 |
| | return r5 |
| I1: | load cor0 <- [r1] |
| | add r3 <- cor0, 1 |
| | coend |
| I2: | cor0 <- [r2] |
| | add r4 <- cor0, 1 |
| | coend- |

In one or more embodiments, instruction set architecture (ISA) instructions may be provided to support the start/end and synchronization of concurrent intervals. These instructions may be referred to as a “cointerval instruction,” a “coend instruction” and a “cowait instruction.” While the following formats are used to describe these instructions and their operation, the instructions may be provided with different syntax in other embodiments.

A cointerval initiation instruction, cointerval r/ptr, includes a field for a source operand (r or ptr) that gives a start address of the concurrent interval. Execution of this instruction assigns this start address value to an available cointerval next instruction pointer. If both pointers are occupied (in an embodiment with 2 cointerval next instruction pointer storages), the address is pushed to a cointerval queue (CoQ), to be activated later. During processor operation, a branch prediction unit (BPU) predicts the value of cointerval next instruction pointers (IPs) in addition to the normal IP to identify the next fetching address of active cointervals. In one or more embodiments, a processor fetches instructions from one of the three pointers in round robin every clock cycle.

Another instruction in accordance with an embodiment, a cointerval end instruction (coend), indicates the end of the current cointerval. When detected early in a decoder, the corresponding cointerval next instruction pointer is invalidated, and instructions following this coend instruction are cleared from pipeline queues, including instruction and micro-operation (uop) queues. Upon execution of this instruction, the BPU arbitrates between entries in the CoQ to determine a next cointerval, e.g., in a first in first out (FIFO) manner.

Yet another cointerval instruction, a cointerval wait instruction (cowait), is used to inform a processor to stop fetch from a current main sequence and wait until all other concurrent intervals finish, meaning that both the CoQ and the cointerval next instruction pointers are empty or invalid. This instruction may also be detected early after decoding.

In general, the process of decoding, allocating and scheduling instructions operates similarly to simultaneous multi-threading, with the following exceptions: there are three (e.g.,) executing sequences: main stream and two active cointervals; instruction and uop queues are partitioned by the three sequences (note a small size of entries may be reserved for the main sequence as it suspends when encountering a cowait instruction and resumes after the cointervals finish running); the architecture state, general registers, and stack frame are shared by the three sequences; only a small set of interval registers are duplicated for each active cointerval. For example, one register alias table (RAT) is used to track the general registers and an additional RAT per active cointerval is used to access the cointerval register file.

Based on simulations and assuming a 4 instruction throughput and 4 cycles of load latency (and not considering branch prediction for both cointerval and jump instructions), for an example code sequence execution cycles can be reduced by at least approximately 40% using cointervals. If considering early direct branch target detection after decoding, cointerval operation can reduce cycle count by approximately 20%. Cointerval gains more when the branch miss penalty is high. This is the case when the intervals are small and can be fetched in a single cycle. Benefits of cointervals can expand when the intervals are of a large size or contain additional jumps that delay parallelism among intervals.

To enable the concurrent interval mechanism for a bytecode interpreter and achieve bytecode level parallelism, the following adjustments may occur: compilation of bytecode handlers using coregs to store intermediate data; dependence analysis may be performed in bytecode generation to identify partitions of consecutive bytecodes to run concurrently, for each partition, a cointerval is created to dispatch the range of bytecodes assigned in it; and registers may be assigned for input and output values passing through the cointervals, e.g., handler parameter and return values.

In one or more embodiments, an interpreter allocates stack frames at the entries of each bytecode function. All locals are allocated in the function's stack frame as bytecode registers, and thus there is no additional stack slot allocation in bytecode handlers. For an indirect/direct threaded interpreter, each handler is run directly through the address in bytecode or indirectly via lookup through a jump table using bytecode. Note that it is possible that each handler will call other functions or built-ins. One possible solution is to make the calls from co-interval to execute in sequence atomically without intersection. That means that the next call can only start when the previous call finishes from any co-intervals.

Consider the following native bytecode sequence in Table 2, as may be generated by a Javascript engine.

TABLE 2

| | | |
|---|---|---|
| 0x142082d28c6 @ | 0:0c 01 | LdaConstant [1] |
| 0x142082d28c8 @ | 2:26 fa | Star r0 |
| 0x142082d28ca @ | 4:28 03 00 01 | LdaNamedProperty a0, [0] |
| 0x142082d28ce @ | 8:35 fa 00 | Add r0, [0] |

The first bytecode 0c01 loads a constant int from address [1] in a constant pool. The second bytecode 26fa stores the result to r0. The third bytecode loads a property from parameter a0. The fourth bytecode adds the result of previous bytecode to r0.

Both the first and third bytecodes will load data from memory, and they can execute independently. The second bytecode is dependent to the first one only and is able to execute independently to the third bytecode as well.

Without an embodiment, even though processor supports out-of-order execution for ILP, the handlers are fetched in sequence, and thus suffer from indirect calls or jumps to fetch the handlers one by one. Since most instructions in each handler are dependent, they will occupy a reservation station buffer long until the dependent instruction is executed, and it will take more cycles for the next independent instruction to arrive. Thus without an embodiment, powerful capabilities of an OOO engine are wasted, reducing instructions per cycle. Moreover if new handlers are invoked through indirect calls, the OOO execution will also be constrained by stack operation dependence and cannot parallelly run across handlers. This again cannot fully utilize the out-of-order execution resources of the processor.

Now consider the following code snippet of Table 3 that shows partitions of bytecode sequences of P0, P1 and Sync. Both P0 and P1 can be dispatched concurrently, while the Sync partition only executes after P0 and P1 finish. Note that for the bytecodes listed, all arguments are already embedded in bytecode and can be interpreted directly in a handler. The “Star r0” bytecode in P0 will writes back the result to the interpreter register frame slot, with no additional value passing back from handler.

The interpretation of P0, P1 and Sync is illustrated in the below pseudocode of Table 3. To distinguish the r0 register used in bytecode, we will number the register in pseudo code in two bits starting from 00. The r00 to r01 and r02 to r03 represent the bytecode range in P0 and P1 respectively.

Here a handler adjustment can be made by storing the return address of the handler to a fixed coreg and jumping back to it at the end of each handler.

TABLE 3

| | |
|---|---|
| r00 = 0 | // First bytecode index in P0 |
| r01 = 2 | // Last bytecode index in P0 |

cointerval P0

| | |
|---|---|
| r02 = 4 | // First bytecode index in P1 |
| r03 = 4 | // Last bytecode index in P1 |

cointerval P1
cowait

| | |
|---|---|
| ... | // Handle bytecodes after Sync. |

P0:

| cor0 = r00; | |
|---|---|
| cor1 = L0; | // Address to jump back from threaded handler |

| | |
|---|---|
| | do |
| | goto Handler of cor0; |
| L0: | cor0++; |
| | while (cor0 <= r01); |
| | coend |

P1:

| | cor0 = r02; | |
|---|---|---|
| | cor1 = L1; | // Address to jump back from threaded handler |
| | do | |
| | goto Handler of cor0; | |
| L1: | cor0++; | |
| | while (cor0 <= r03); | |
| | r04 <− cor1 | // Assume coreg1 stores return value from |
| | | handler |

coend

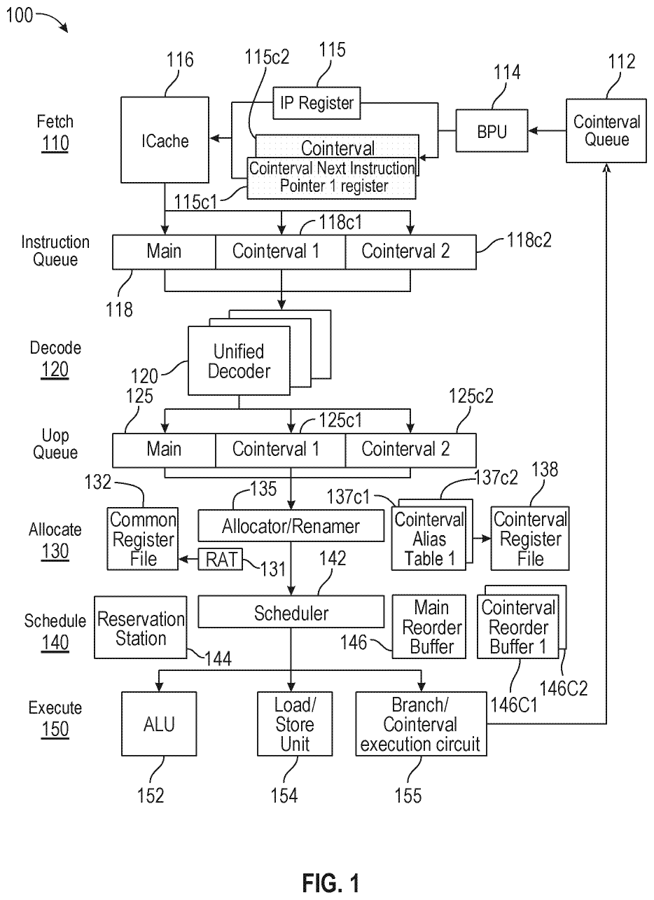

Various hardware may be present in a processor core to support cointerval execution in accordance with an embodiment. Referring now to FIG. 1, shown is a block diagram of a processor core in accordance with an embodiment. More specifically as shown in FIG. 1, core 100 illustrates an out-of-order pipeline having support for cointerval processing. As such, core 100 is configured with hardware circuitry to perform simultaneous processing of instructions of a main sequence and instructions of one or more cointervals.

As illustrated in the high level of FIG. 1, core 100 has a multi-stage pipeline including a fetch stage 110, a decode stage 120, an allocate stage 130, a schedule stage 140 and an execute stage 150. With reference first to fetch stage 110, included is a cointerval queue 112. As described herein, cointerval queue 112 may store one or more addresses corresponding to a start of a concurrent interval. Cointerval queue 112 couples to a branch prediction unit (BPU) 114 which may provide branch predictions both for the main sequence and cointervals. Thus as illustrated, BPU 114 may provide address predictions to an instruction pointer storage 115 that is a next IP storage such as a register that stores an address of a next instruction for the main sequence. Similarly, two cointerval next instruction pointer storages 115_{C1, C2} are present, each to store an address of a next instruction for a given active cointerval. While hardware support for simultaneous execution of two cointervals in addition to a main sequence is illustrated, in other cases, a processor may provide support for more than two simultaneous cointervals.

As further shown, instruction pointer storages 115 couple to an instruction cache 116 which may store instructions for both the main sequence and active cointervals. As shown, instruction cache 116 couples to an instruction queue 118 that may be partitioned into a main sequence portion and multiple cointerval portions 118_{C1, C2}. Instructions from instruction queue 118 are provided to decode stage 120, which includes a unified decoder 120 which may decode instructions of the main sequence and the cointervals. Depending upon implementation, a single decoder unit or multiple partitioned decoder units may be present.

In any case, the decoded instructions are provided to a micro-operation (uop) queue 125 which as shown may be segmented with a main portion 125 to store decoded uops of the main sequence and segments 125_{C1,C2} to store decoded uops for the active cointervals.

Next with reference to allocate stage 130, an allocator/renamer 135 may allocate resources in a common register file 132 that is accessible both to main sequence and the active cointervals, and a cointerval register file 138 that is only used by the cointervals. As illustrated, a register alias table 131 couples to common register file 132 and one or more cointerval alias tables 137_{C1, C2} couple to cointerval register file 138.

Further with reference to FIG. 1, the allocated instructions are provided to schedule stage 140 and more specifically to a scheduler 142 which may schedule instructions of the main sequence and active cointervals for execution. To this end, scheduler 142 may interact with a reservation station 144 and reorder buffers, including a main reorder buffer 146 and cointerval reorder buffers 146_{C1, C2}.

Finally as illustrated in FIG. 1, execute stage 152 includes various execution circuitry, including an arithmetic logic unit (ALU) 152, a load/store circuit 154, both of which may execute instructions of the main sequence and the active cointervals. In addition, a branch/cointerval execution circuit 155 may execute branch instructions and various cointerval instructions, including the cointerval instructions disclosed herein. While shown at this high level in the embodiment of FIG. 1, many variations and alternatives are possible.

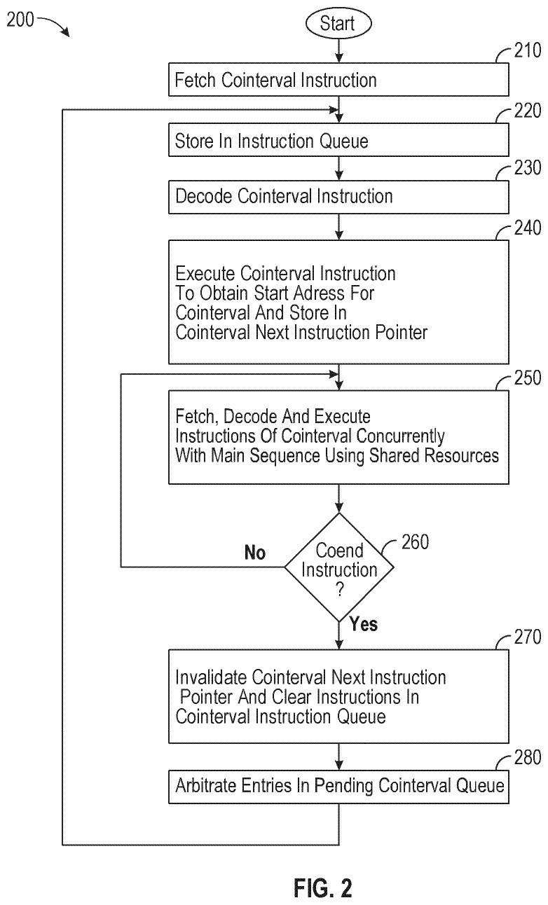

Referring now to FIG. 2, shown is a flow diagram of a method in accordance with an embodiment. More specifically as shown in FIG. 2, method 200 is a method for executing code including cointerval instructions as described herein. In an embodiment, method 200 may be performed by circuitry of a processor core, such as that discussed above in FIG. 1, alone and/or in combination with firmware and/or software.

As illustrated, method 200 begins during execution of a main sequence by fetching a cointerval instruction (block 210). This instruction, which may be fetched by a fetch stage, is stored in an instruction queue (block 220), (and possibly first stored in an instruction cache before being stored into the instruction queue). More specifically, this instruction is a cointerval start instruction, which is used to obtain a start address for a cointerval.

Next at block 230, the cointerval instruction may be decoded. After appropriate allocation and scheduling of the instruction, the cointerval instruction may be executed (block 240). More specifically, execution of this cointerval start instruction results in obtaining a start address from a location identified by a source operand of the cointerval instruction. This start address may be stored in a cointerval next instruction pointer based on the execution of the instruction. Note however that if cointerval next instruction pointer resources are full, instead this start address may be stored in a cointerval queue.

Still with reference to FIG. 2, thereafter at block 250, instructions of this cointerval may be fetched, decoded and executed. Note that such cointerval execution may occur concurrently with execution of the main sequence and where active, at least one other cointerval. Such instruction execution may occur so long as there are instructions present within the cointerval.

When it is determined that a coend instruction is received (diamond 260), control passes to block 270. At block 270, the cointerval next instruction pointer may invalidated. Furthermore, additional instructions in the cointerval instruction queue (both in an instruction queue and potentially a uop queue) may be cleared. As such, this active cointerval may be completed. Control next passes to block 280 where entries in a pending cointerval queue may be arbitrated. Such arbitration may proceed, in one embodiment, according to a first in first out (FIFO) order, although other possibilities exist. While shown at this high level in the embodiment of FIG. 2, many variations and alternatives are possible. For example, a cowait instruction may occur during the main sequence, which causes the main sequence to be halted until one or more cointervals complete execution.

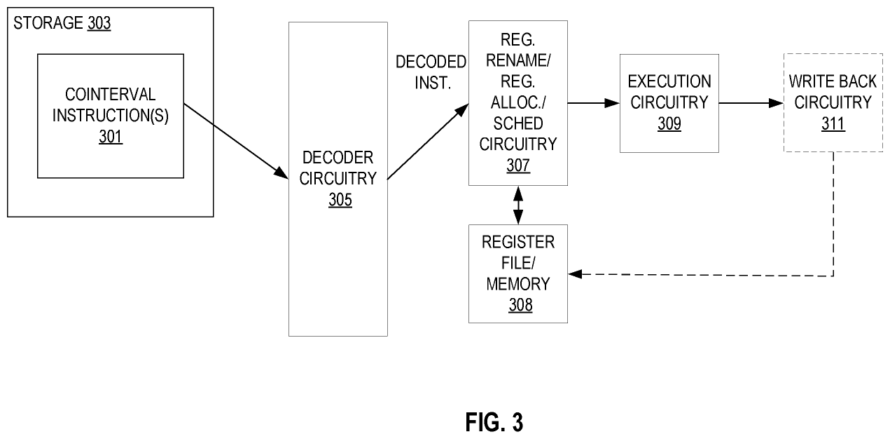

FIG. 3 illustrates examples of computing hardware to process one or more cointerval instructions. The instruction may be a particular cointerval instruction, such as cointerval initialization instruction. As illustrated, storage 303 stores a cointerval start instruction 301 to be executed.

The instruction 301 is received by decoder circuitry 305. For example, the decoder circuitry 305 receives this instruction from fetch circuitry (not shown). In an example, the instruction includes fields for an opcode and at least a source identifier. In some examples, the source is a register, and in other examples one or more are memory locations. In some examples, one or more of the sources may be an immediate operand. In some examples, the opcode details the initialization of a cointerval by obtaining a starting address using a source operand and storing the starting address in a cointerval instruction pointer storage.

More detailed examples of at least one instruction format for the instruction will be detailed later. The decoder circuitry 305 decodes the instruction into one or more operations. In some examples, this decoding includes generating a plurality of micro-operations to be performed by execution circuitry (such as execution circuitry 309). The decoder circuitry 305 also decodes instruction prefixes.

In some examples, register renaming, register allocation, and/or scheduling circuitry 307 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 308 store data as operands of the instruction to be operated by execution circuitry 309. Example register types include packed data registers, general purpose registers (GPRs), and floating-point registers.

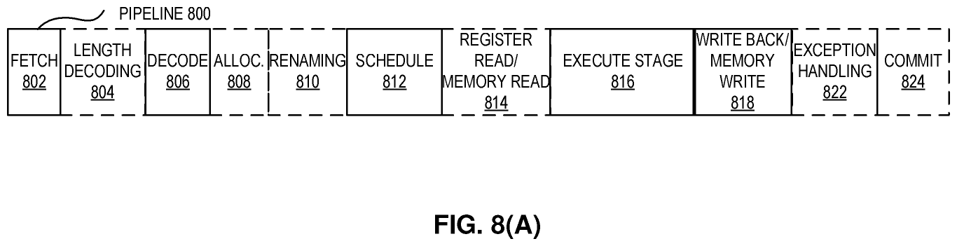

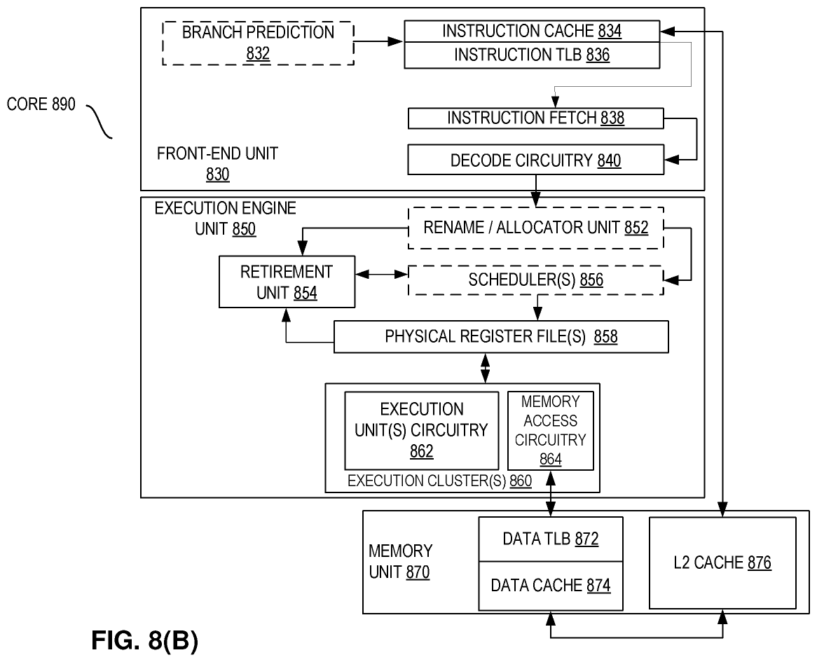

Execution circuitry 309 executes the decoded instruction. Example detailed execution circuitry includes execution circuitry 309 shown in FIG. 3, and execution cluster(s) 860 shown in FIG. 8(B), etc. The execution of the decoded instruction causes the execution circuitry to perform the operations discussed above.

In some examples, retirement/write back circuitry 311 architecturally commits the destination register into the registers or memory 308 and retires the instruction.

An example of a format for a cointerval start instruction is OPCODE SRC1. In some examples, OPCODE is the opcode mnemonic of the instruction. SRC1 is a field for the source operand, such as a data register and/or memory.

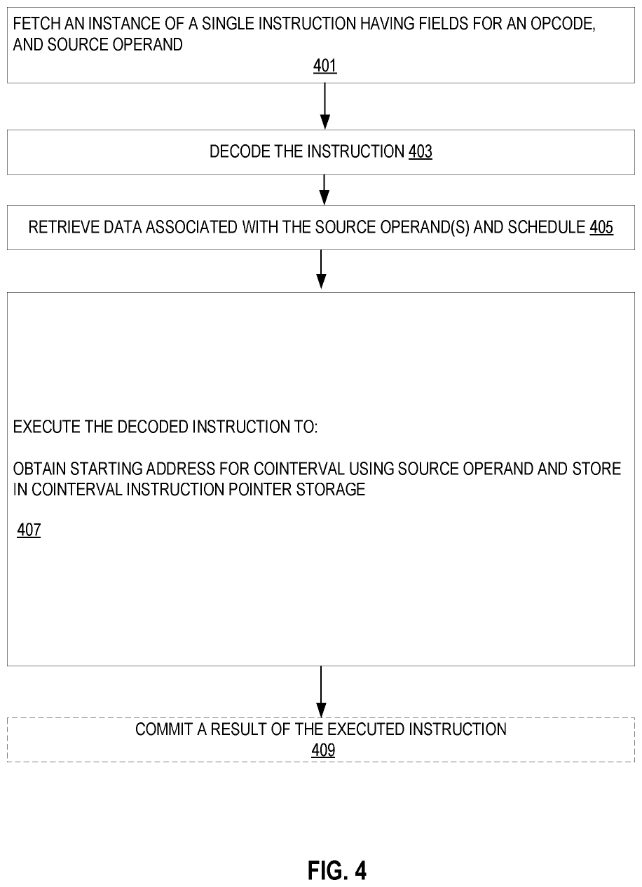

FIG. 4 illustrates an example method performed by a processor to process a cointerval start instruction. For example, a processor core as shown in FIG. 8(B), a pipeline as detailed below, etc., performs this method.

At 401, an instance of single instruction is fetched. For example, an cointerval start instruction is fetched. The instruction includes fields for an opcode and a source operand. In some examples, the instruction is fetched from an instruction cache. The opcode indicates the operations to perform.

The fetched instruction is decoded at 403. For example, the fetched cointerval start instruction is decoded by decoder circuitry such as decoder circuitry 305 or decode circuitry 840 detailed herein.

Data values associated with the source operand of the decoded instruction are retrieved when the decoded instruction is scheduled at 405. For example, when one or more of the source operands are memory operands, the data from the indicated memory location is retrieved.

At 407, the decoded instruction is executed by execution circuitry (hardware) such as execution circuitry 309 shown in FIG. 3, or execution cluster(s) 860 shown in FIG. 8(B). For the cointerval start instruction, the execution will cause execution circuitry to perform certain of the operations described in connection with FIG. 2, namely to obtain a starting address for the cointerval using the source operand and store the starting address into a cointerval instruction pointer storage (or a pending cointerval queue, if no resources are available).

In some examples, the instruction is committed or retired at 409.

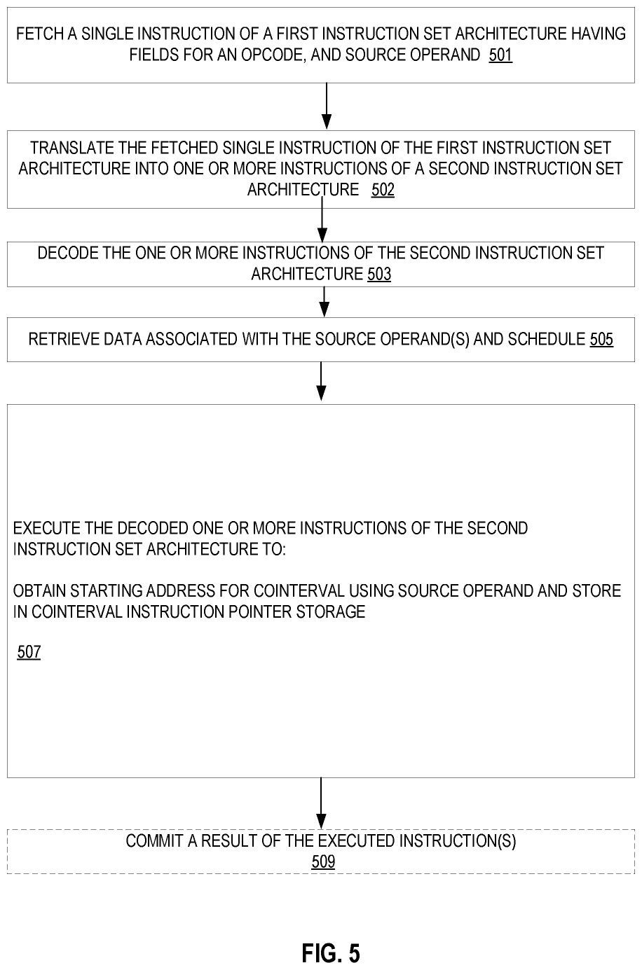

FIG. 5 illustrates an example method to process a cointerval start instruction using emulation or binary translation. For example, a processor core as shown in FIG. 8(B), a pipeline and/or emulation/translation layer perform aspects of this method.

An instance of a single instruction of a first instruction set architecture is fetched at 501. The instance of the single instruction of the first instruction set architecture includes fields for an opcode and source operand.

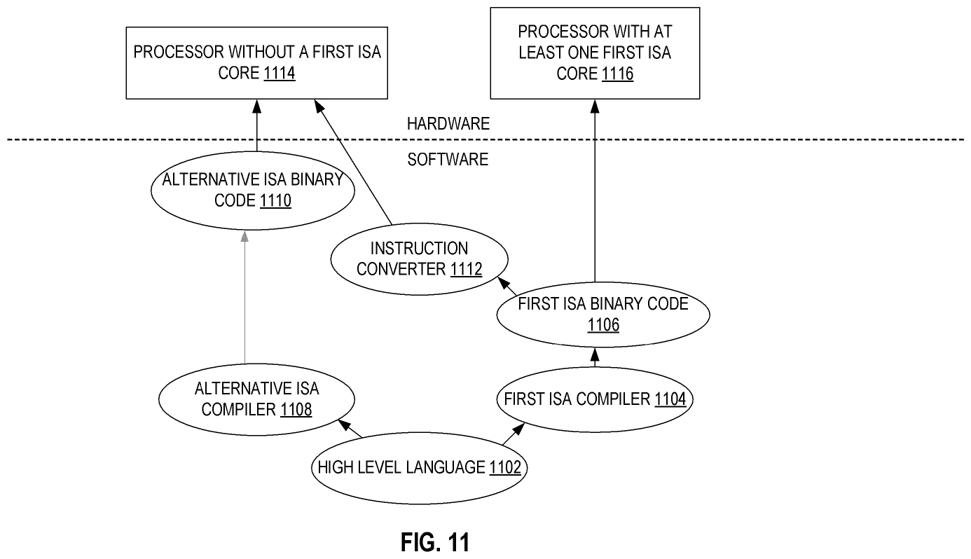

The fetched single instruction of the first instruction set architecture is translated into one or more instructions of a second instruction set architecture at 502. This translation is performed by a translation and/or emulation layer of software in some examples. In some examples, this translation is performed by an instruction converter 1112 as shown in FIG. 11. In some examples, the translation is performed by hardware translation circuitry.

The one or more translated instructions of the second instruction set architecture are decoded at 503. For example, the translated instructions are decoded by decoder circuitry such as decoder circuitry 305 or decode circuitry 840 detailed herein. In some examples, the operations of translation and decoding at 502 and 503 are merged.

Data values associated with the source operand(s) of the decoded one or more instructions of the second instruction set architecture are retrieved and the one or more instructions are scheduled at 505. For example, when one or more of the source operands are memory operands, the data from the indicated memory location is retrieved.

At 507, the decoded instruction(s) of the second instruction set architecture is/are executed by execution circuitry (hardware) such as execution circuitry 309 shown in FIG. 3, or execution cluster(s) 860 shown in FIG. 8(B), to perform the operation(s) indicated by the opcode of the single instruction of the first instruction set architecture, as discussed above. In some examples, the instruction is committed or retired at 509.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

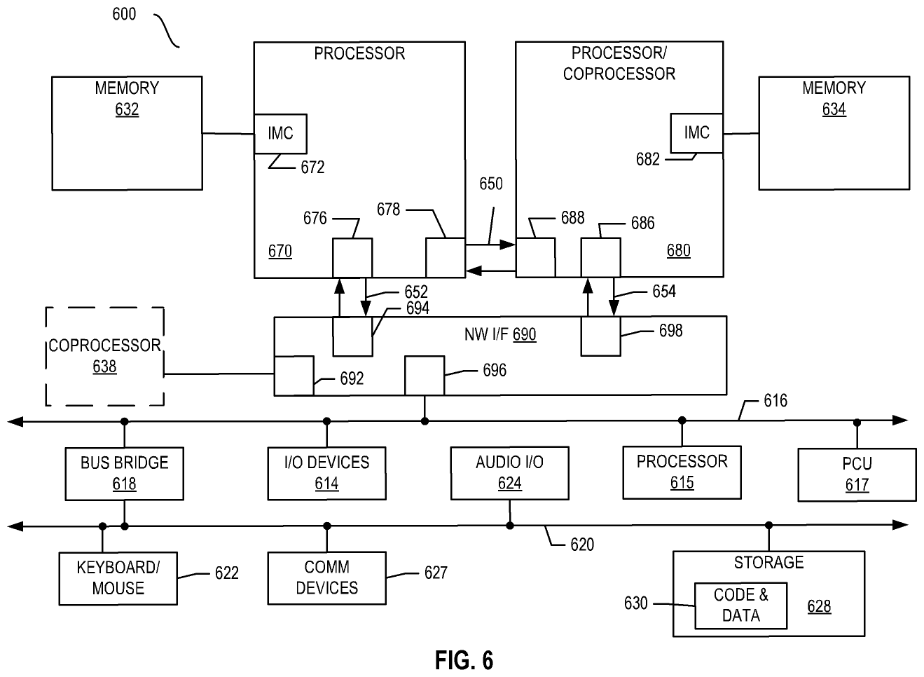

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. One or more of the cores may include hardware support (such as discussed in FIG. 1) for performing cointerval instructions as described herein. In some examples, the first processor 670 and the second processor 680 are homogeneous. In some examples, first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect (PCI) interconnect, a PCI Express interconnect or another I/O interconnect. In some examples, first interface 616 is coupled to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 303 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Understand that the terms “system on chip” or “SoC” are to be broadly construed to mean an integrated circuit having one or more semiconductor dies implemented in a package, whether a single die, a plurality of dies on a common substrate, or a plurality of dies at least some of which are in stacked relation. Thus as used herein, such SoCs are contemplated to include separate chiplets, dielets, and/or tiles, and the terms “system in package” and “SiP” are interchangeable with system on chip and SoC. Example core architectures are described next, followed by descriptions of example processors and computer architectures.

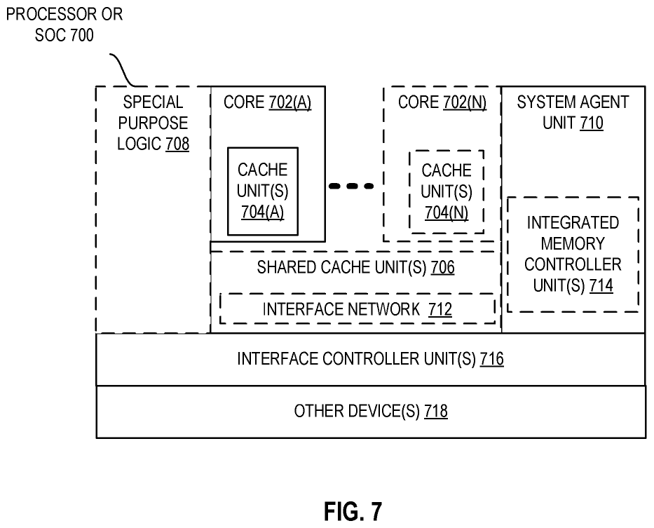

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller units circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading, and also concurrently executing one or more cointervals with a main sequence as described herein. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

### Example Core Architectures—In-Order and Out-of-Order Core Block Diagram.

FIG. 8(A) is a block diagram illustrating both an example in-order pipeline and an example register renaming, out-of-order issue/execution pipeline according to examples. FIG. 8(B) is a block diagram illustrating both an example in-order architecture core and an example register renaming, out-of-order issue/execution architecture core to be included in a processor according to examples. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8(B) may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8(B) shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry, and includes one or more concurrent interval register files, in addition to a common register file, as described herein. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry.

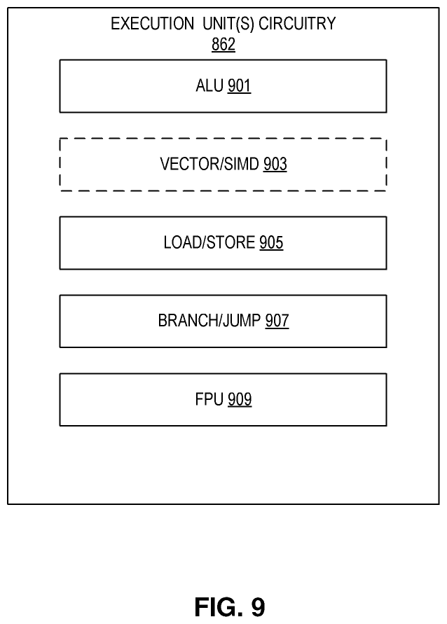

FIG. 9 illustrates examples of execution unit(s) circuitry, such as execution unit(s) circuitry 862 of FIG. 8(B). As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

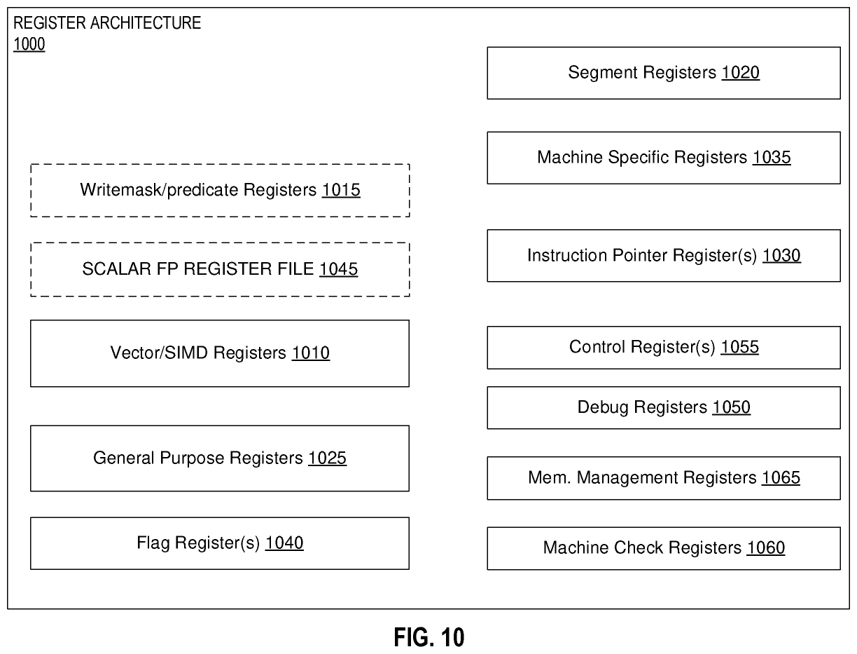

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register file 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1000 may, for example, be used in register file/memory 308, or physical register file(s) circuitry 858. Note that in some embodiments, there may be at least two sets of general-purpose registers 1025 (among some of the other registers) to accommodate cointerval operation as described herein.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 11 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 11 shows a program in a high-level language 1102 may be compiled using a first ISA compiler 1104 to generate first ISA binary code 1106 that may be natively executed by a processor with at least one first ISA core 1116. The processor with at least one first ISA core 1116 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1104 represents a compiler that is operable to generate first ISA binary code 1106 (e.g., object code) that can, with or without additional linkage processing, be executed on the processor with at least one first ISA core 1116. Similarly, FIG. 11 shows the program in the high-level language 1102 may be compiled using an alternative ISA compiler 1108 to generate alternative ISA binary code 1110 that may be natively executed by a processor without a first ISA core 1114. The instruction converter 1112 is used to convert the first ISA binary code 1106 into code that may be natively executed by the processor without a first ISA core 1114. This converted code is not necessarily to be the same as the alternative ISA binary code 1110; however, the converted code will accomplish the general operation and be made up of instructions from the alternative ISA. Thus, the instruction converter 1112 represents software, firmware, hardware, or a combination thereof that, through emulation, simulation or any other process, allows a processor or other electronic device that does not have a first ISA processor or core to execute the first ISA binary code 1106.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

The following examples pertain to further embodiments.

In one example, an apparatus comprises: a first plurality of registers to store information of at least a main sequence; a second plurality of registers to store information of at least one concurrent interval, the at least one concurrent interval independent of the main sequence, where the second plurality of registers are accessible only by instructions of the at least one concurrent interval and the first plurality of registers are accessible by instructions of the main sequence and the at least one concurrent interval; and an execution circuit coupled to the first register file and the second register file, the execution circuit to execute the instructions of the main sequence and the at least one concurrent interval.

In an example, the apparatus further comprises: a first IP storage to store an IP for the main sequence; and a second IP storage to store an IP for the at least one concurrent interval.

In an example, the second IP storage comprises a plurality of second IP storages each to store an IP for an active concurrent interval.

In an example, in response to a first concurrent interval instruction having a field to represent a source operand, the source operand to identify a location of a start address of a first concurrent interval, the execution circuit is to store the start address of the first concurrent interval in the second IP storage.

In an example, the apparatus further comprises a fetch circuit to fetch an instruction of the first concurrent interval from the start address.

In an example, the apparatus further comprises a branch predictor to predict a direction of one or more branch instructions within the main sequence and the at least one concurrent interval.

In an example, the branch predictor is to provide a branch prediction for a first branch instruction within the at least one concurrent interval to the second IP storage.

In an example, the apparatus further comprises memory to store a queue, the queue to store a starting address of a first pending concurrent interval, where in response to completion of a first concurrent interval the queue is to provide the starting address of the first pending concurrent interval to the second IP storage.

In an example, the apparatus further comprises an instruction queue to store instructions, where the instruction queue comprises a plurality of partitions, one or more of the plurality of partitions associated with the at least one concurrent interval.

In an example, in response to a concurrent interval end instruction, the apparatus is to remove one or more instructions of the at least one concurrent interval from the instruction queue and invalidate an instruction pointer of the at least one concurrent interval in a concurrent interval instruction pointer storage.

In an example, the apparatus, in response to a concurrent interval wait instruction, is to halt fetch of instructions of the main sequence until execution of the at least one concurrent interval is completed.

In another example, a method comprises: in response to a concurrent interval instruction having a first field to represent a source operand, obtaining an address from the source operand and storing the address in a concurrent interval instruction pointer storage, the address a starting address of a first concurrent interval, the concurrent interval instruction to initiate execution of the first concurrent interval concurrently with a main sequence; and executing one or more instructions of the first concurrent interval in a pipeline of a processor concurrently with execution of one or more instructions of the main sequence in the pipeline of the processor.

In an example, the method further comprises accessing one or more operands of the one or more instructions of the first concurrent interval from a concurrent interval register file, the concurrent interval register file separate from a common register file, the concurrent interval register file accessible within the first concurrent interval, and the common register file accessible within the first concurrent interval and the main sequence.

In an example, the method further comprises predicting, in a branch prediction circuit, a next instruction for the first concurrent interval and storing an address of the next instruction in the concurrent interval instruction pointer storage.

In an example, the method further comprises executing the one or more instructions of the first concurrent interval concurrently with the one or more instructions of the main sequence, where the first concurrent interval and the main sequence are of a single thread.

In an example, the method further comprises: in response to a concurrent interval end instruction, flushing one or more queues of the pipeline of the processor of instructions of the first concurrent interval; selecting a start address for another concurrent interval in a concurrent interval queue; and storing the selected start address in the concurrent interval instruction pointer storage, to cause the another concurrent interval to begin execution.

In an example, the method further comprises, in response to a concurrent interval wait instruction, halting execution of the main sequence until the at least one concurrent interval is completed.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises a processor having one or more cores and a system memory coupled to the processor. At least of the one or more cores has a pipeline comprising: an instruction pointer storage to store an instruction pointer for a main sequence and another instruction pointer for at least one other sequence, the at least one other sequence independent of the main sequence, the main sequence and the at least one other sequence of a single thread; a first plurality of registers to store information of at least the main sequence; a second plurality of registers to store information of the at least one other sequence, where the second plurality of registers are accessible only by instructions of the at least one other sequence and the first plurality of registers are accessible by instructions of the main sequence and the at least one other sequence; and an execution circuit coupled to the first plurality of registers and the second plurality of registers, the execution circuit to execute instructions of the main sequence and the at least one other sequence.

In an example, the processor, in response to a first instruction having a field to represent a source operand, the source operand to identify a location of a start address of the at least one other sequence, is to store the start address of the at least one other sequence in the instruction pointer storage.

In an example, the processor: in response to a wait instruction, is to halt fetch of instructions of the main sequence; in response to one or more instructions of the at least one other sequence, is to perform one or more operations and store at least one result in at least one destination storage; and in response to an end instruction, is to continue execution of the main sequence, where during the continued execution of the main sequence, the execution circuit is to use the at least one result.

In yet another example, an apparatus comprises: means for obtaining an address from a source operand of a concurrent interval instruction having a first field to represent a source operand; means for storing the address in a concurrent interval instruction pointer storage means, the address a starting address of a first concurrent interval, the concurrent interval instruction to initiate execution of the first concurrent interval concurrently with a main sequence; and means for executing one or more instructions of the first concurrent interval in a pipeline means of a processor means concurrently with execution of one or more instructions of the main sequence in the pipeline means of the processor means.

In an example, the apparatus further comprises means for accessing one or more operands of the one or more instructions of the first concurrent interval from a concurrent interval register file means, the concurrent interval register file means separate from a common register file means.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

1. An apparatus comprising:
a first plurality of registers to store information of at least a main sequence;
a second plurality of registers to store information of at least one concurrent interval, the at least one concurrent interval independent of the main sequence, wherein the second plurality of registers are accessible only by instructions of the at least one concurrent interval and the first plurality of registers are accessible by instructions of the main sequence and the at least one concurrent interval; and
an execution circuit coupled to the first plurality of registers and the second plurality of registers, the execution circuit to execute the instructions of the main sequence and the at least one concurrent interval.

2. The apparatus of claim 1, further comprising:
a first instruction pointer (IP) storage to store an IP for the main sequence; and
a second IP storage to store an IP for the at least one concurrent interval.

3. The apparatus of claim 2, wherein the second IP storage comprises a plurality of second IP storages each to store an IP for an active concurrent interval.

4. The apparatus of claim 2, wherein in response to a first concurrent interval instruction having a field to represent a source operand, the source operand to identify a location of a start address of a first concurrent interval, the execution circuit is to store the start address of the first concurrent interval in the second IP storage.

5. The apparatus of claim 4, further comprising a fetch circuit to fetch an instruction of the first concurrent interval from the start address.

6. The apparatus of claim 2, further comprising a branch predictor to predict a direction of one or more branch instructions within the main sequence and the at least one concurrent interval.

7. The apparatus of claim 6, wherein the branch predictor is to provide a branch prediction for a first branch instruction within the at least one concurrent interval to the second IP storage.

8. The apparatus of claim 2, further comprising memory to store a queue, the queue to store a starting address of a first pending concurrent interval, wherein in response to completion of a first concurrent interval the queue is to provide the starting address of the first pending concurrent interval to the second IP storage.

9. The apparatus of claim 1, further comprising an instruction queue to store instructions, wherein the instruction queue comprises a plurality of partitions, one or more of the plurality of partitions associated with the at least one concurrent interval.

10. The apparatus of claim 9, wherein in response to a concurrent interval end instruction, the apparatus is to remove one or more instructions of the at least one concurrent interval from the instruction queue and invalidate an instruction pointer of the at least one concurrent interval in a concurrent interval instruction pointer storage.

11. The apparatus of claim 1, wherein the apparatus, in response to a concurrent interval wait instruction, is to halt fetch of instructions of the main sequence until execution of the at least one concurrent interval is completed.

12. At least one computer-readable medium comprising instructions that, when executed by a processor, cause the processor to perform a method comprising:
in response to a concurrent interval instruction having a first field to represent a source operand, obtaining an address from the source operand and storing the address in a concurrent interval instruction pointer storage, the address a starting address of a first concurrent interval, the concurrent interval instruction to initiate execution of the first concurrent interval concurrently with a main sequence; and
executing one or more instructions of the first concurrent interval in a pipeline of the processor concurrently with execution of one or more instructions of the main sequence in the pipeline of the processor.

13. The at least one computer-readable medium of claim 12, wherein the method further comprises accessing one or more operands of the one or more instructions of the first concurrent interval from a concurrent interval register file, the concurrent interval register file separate from a common register file, the concurrent interval register file accessible within the first concurrent interval, and the common register file accessible within the first concurrent interval and the main sequence.

14. The at least one computer-readable medium of claim 12, wherein the method further comprises predicting, in a branch prediction circuit, a next instruction for the first concurrent interval and storing an address of the next instruction in the concurrent interval instruction pointer storage.

15. The at least one computer-readable medium of claim 12, wherein the method further comprises executing the one or more instructions of the first concurrent interval concurrently with the one or more instructions of the main sequence, wherein the first concurrent interval and the main sequence are of a single thread.

16. The at least one computer-readable medium of claim 12, wherein the method further comprises:
in response to a concurrent interval end instruction, flushing one or more queues of the pipeline of the processor of instructions of the first concurrent interval;
selecting a start address for another concurrent interval in a concurrent interval queue; and
storing the selected start address in the concurrent interval instruction pointer storage, to cause the another concurrent interval to begin execution.

17. The at least one computer-readable medium of claim 12, wherein the method further comprises, in response to a concurrent interval wait instruction, halting execution of the main sequence until the first concurrent interval is completed.

18. A system comprising:
a processor having one or more cores, at least one of the one or more cores having a pipeline comprising:
an instruction pointer storage to store an instruction pointer for a main sequence and another instruction pointer for at least one other sequence, the at least one other sequence independent of the main sequence, the main sequence and the at least one other sequence of a single thread;
a first plurality of registers to store information of at least the main sequence;
a second plurality of registers to store information of the at least one other sequence, wherein the second plurality of registers are accessible only by instructions of the at least one other sequence and the first plurality of registers are accessible by instructions of the main sequence and the at least one other sequence; and
an execution circuit coupled to the first plurality of registers and the second plurality of registers, the execution circuit to execute instructions of the main sequence and the at least one other sequence; and
a system memory coupled to the processor.

19. The system of claim 18, wherein the processor, in response to a first instruction having a field to represent a source operand, the source operand to identify a location of a start address of the at least one other sequence, is to store the start address of the at least one other sequence in the instruction pointer storage.

20. The system of claim 19, wherein the processor:
in response to a wait instruction, is to halt fetch of instructions of the main sequence;
in response to one or more instructions of the at least one other sequence, is to perform one or more operations and store at least one result in at least one destination storage; and
in response to an end instruction, is to continue execution of the main sequence, wherein during the continued execution of the main sequence, the execution circuit is to use the at least one result.
